(19) United States
(12) Patent Application Publication
(10) Pub. No.: US 2018/0031223 A1
(43) Pub. Date: Feb. 1, 2018

(54) COOLING SYSTEM OF LED LAMP

(71) Applicant: Jianwen Mai, Guangzhou (CN)

(72) Inventor: Jianwen Mai, Guangzhou (CN)

(21) Appl. No.: 15/377,560

(22) Filed: Dec. 13, 2016

(30) Foreign Application Priority Data
Jul. 27, 2016 (CN) 201610622132.7
Jul. 27, 2016 (CN) 201620827423.5
Jul. 27, 2016 (CN) 201620827838.2
Jul. 27, 2016 (CN) 201620827906.5

(51) Int. Cl. F21V 29/58; F21V 23/02; F21V 29/89; F21V 29/67; F21V 25/10

(52) U.S. Cl. CPC F21V 29/59; F21V 29/677; F21V 25/10; F21V 29/89; F21V 23/023; F21Y 2115/10

(57) ABSTRACT

A cooling system of a light emitting diode (LED) lamp includes: a circulatory pipe, a pump, an LED cooling module and a power source cooling module, wherein the LED cooling module is a fluid cooling mechanism for an LED lamp, the power source cooling module is a fluid cooling mechanism for an LED lamp power source module, the circulatory pipe is connected to the LED cooling module and the power source cooling module, the pump is assembled to the circulatory pipe, causing a fluid in the circulatory pipe to flow through the LED cooling module and the power source cooling module and form a circulatory flow, thereby achieving a cooling and temperature reducing function of the LED lamp and the power source module at the same time.

### RELATED APPLICATIONS

This application claims priority under 35 FU.S.C. §119 to Chinese Patent Application Nos. 201620827906.5, 201620827838.2, 201620827423.5, and 201610622132.7, all filed only 27, 2016. The entire teachings of the above applications are incorporated herein by reference in their entirety.

### FIELD OF THE INVENTION

The present disclosure relates to a cooling system of a light emitting diode (LED) lamp.

### BACKGROUND OF THE INVENTION

As we all know, a light emitting diode (LED) has a high luminous efficiency, a long service life and low power consumption, thus it is widely developed and applied. However, because an application temperature of the LED lamp is excessively high which reduces a luminous intensity, thereby influencing a luminous efficiency and a lighting quality, and seriously influencing a service life thereof. It is most serious, particularly when it is applied to a high power LED lamp. Therefore, the technical problem of an excessive high temperature has become a big obstacle for a popularization and promotion of the LED lamp.

The cooling of the existing LED lamp are mainly divided into two types which are air cooling structure and liquid cooling structure. Because a slow cooling rate of the air cooling, it is difficult to be applied to a high power LED lamp, the liquid cooling has an effect better than the air cooling. However, the structure of the liquid cooling has defects, such as a large volume, a high cost, thus its application is limited and it is difficult to be popularized. In the application, a power source board generates a large quantity of heat simultaneously, to the extent that a service life the whole LED lamp is influenced. So far, the cooling problem of the power source board does not gain more attention from the technological person.

### SUMMARY

Accordingly, it is necessary to provide a cooling system of a light emitting diode (LED) lamp which has a better cooling function and is directed to address above shortcomings in the cooling of the conventional LED lamp.

A cooling system of an LED lamp includes: a circulatory pipe, a pump, an LED cooling module, and a power source cooling module, wherein the LED cooling module is a fluid cooling mechanism for an LED lamp, the power source cooling module is a fluid cooling mechanism for an LED lamp power source module, the circulatory pipe is connected to the LED cooling module and the power source cooling module, the pump is assembled to the circulatory pipe, causing a fluid in the circulatory pipe to flow through the LED cooling module and the power source cooling module and form a circulatory flow, thereby achieving a cooling and temperature reducing function of the LED lamp and the power source module at the same time.

According to an embodiment, the circulatory pipe is further provided with a heat sink.

According to an embodiment, the heat sink includes a fan and a water passage, the water passage is consisted by a plurality of sheet-like delivery pipes, each has a square cross-section, each sheet-like delivery pipe is provided with a cooling sheet having a wavy sheet-like structure, the cooling sheet is configured to conduct the heat of the fluid in the sheet-like delivery pipes, the sheet-like delivery pipes includes an inlet and an outlet connected to the circulatory pipe, respectively, causing the fluid in the circulatory pipe to circulatory flow through the water passage, and transfer the heat to the cooling sheet to reduce a temperature, the fan is assembled to a side of the water passage to enable the fan to blow air through the water passage and bypass the cooling sheet.

According to an embodiment, each of the inlet and the outlet of the water passage is connected to a water collector tank, the two water connector tanks are located on opposite ends of each of the water passage and the cooling sheet, the two water connector tanks, the water passage, and the cooling sheet form an integrally structure, or the inlet and the outlet are provided with one water connector tank receiving the fluid, the circulatory pipe is connected to the water passage via the water passage.

According to an embodiment, the LED cooling module is a first sealing box closely contacting a base of the LED lamp and is made of heat conducive materials, the LED cooling module is configured to receive the fluid, the LED cooling module includes a sealing case which is provided with a first inlet and a first outlet connected to the circulatory pipe, the fluid is poured into the sealing case via the first inlet, and is discharged via the first outlet, the sealing case has a side panel and a heating body, the side panel is consisted by a cooling plate laminated on the heating body, the heat of the heating body is conducted to the fluid in the sealing case via the cooling plate to perform a circulatory cooling process.

According to an embodiment, the power source cooling module is a second sealing box closely contacting the power source module and is made of heat conducive materials, the power source cooling module is configured to receive the fluid.

According to an embodiment, each of the first sealing box and the second sealing box is provided with a cooling conduit, the cooling conduit extends through the first sealing box and the second sealing box, and the cooling conduit has an inlet and an outlet which are connected to the circulatory pipe, respectively.

According to an embodiment, the LED cooling module and the power source cooling module are connected to the circulatory pipe in parallel or by a series connection.

According to an embodiment, the cooling plate is provided with a plurality of cooling sheets in an inner side thereof, the plurality of cooling sheets are evenly distributed in an inner chamber of the sealing case.

According to an embodiment, the cooling plate is provided with a pair of assembly grooves, the sealing case has a square or a circular shape and has a peripheral side edge engaging the assembly grooves tightly and assembled to the cooling plate.

According to an embodiment, an engaging position of the side edge and the assembly groove is filled with an anti-leakage sealing material.

According to an embodiment, the cooling plate and the heating body contact each other tightly by a heat conductive adhesive.

According to an embodiment, the heating body is an LED lamp or a power source module.

According to an embodiment, the circulatory pipe and/or the sealing case are made of heat conductive materials.

According to an embodiment, the cooling system of an LED lamp further includes a protective mechanism, wherein the protective mechanism includes a temperature sensor and a control power circuit.

The present disclosure possesses prominent advantages as follows:

The present disclosure includes a circulatory pipe, a pump, an LED cooling module, and a power source cooling module, such that not only the LED lamp is cooled, but also the power source module is cooled. Therefore, a cooling effect of the whole LED lamp equipment is effectively guaranteed, a luminous effect and quality of the LED lamp is improved, and damage to the power source module due to heating is avoided, thereby effectively prolonging a service life.

The circulatory pipe of the present disclosure is provided with a heat sink, the heat sink includes a fan and a water passage, the water passage is consisted by a plurality of sheet-like delivery pipes, each has a square cross-section, thereby the cooling area of the water passage is increased, and the volume of the heat sink is reduced and the cooling effect of the LED lamp is effective improved.

Each sheet-like delivery pipe of the present disclosure is provided with a cooling sheet having a wavy sheet-like structure, the cooling sheet is configured to conduct the heat of the fluid in the sheet-like delivery pipe, therefore, the conductive and cooling area of the water passage is increased, the volume of the heat sink is further reduced, and the heat of the fluid (cooling liquid such as silicone oil and water which has better heat conductive characteristics are included) in the water passage is conducted out, thereby further enhancing a cooling function of the fluid, and a better cooling effect is achieved, causing the LED lamp, the power source module, and even the whole LED lamp (i.e. the LED lighting) to obtain a better cooling effect, thus the operational performance of the LED lamp is effective improved and the service life of the LED lamp is prolonged.

Each of the inlet and the outlet of the water passage of the present disclosure is connected to a water collector tank, or the inlet and the outlet are provided with one water collector tank receiving fluid, the circulatory pipe is connected to the water passage via the water collector tank, thus increasing a circulation volume of the fluid in the circulatory pipe; so as to improve the cooling effect of the LED lamp.

The water collector tank, the water passage, and the heat sink sheets of the present disclosure form an integrally structure, thus it has a compact structure and is convenient to assembly, and further has a high assembly effect.

The cooling system of the present disclosure further includes a protective mechanism, therefore, when in use, the LED the present disclosure has a better self-protection function; thus even if a failure or a damage of a cooling function emerges, the LED lamp cannot be damaged or destroyed.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a perspective view of a cooling system of a light er sitting diode (LED) lamp according to a first embodiment;

FIG. 2 is a perspective view of the cooling system of the LED lamp of FIG. 1 with an LED lamp and a fan disassembled;

FIG. 3 is an exploded view of a heat sink of the cooling system of the LED lamp according to the first embodiment with the fan removed;

FIG. 4 is a side view of a water passage and a cooling sheet according to the first embodiment;

FIG. 5 is a perspective view of an LED cooling module according to the first embodiment;

FIG. 6 is a cross-sectional view of the LED cooling module of FIG. 5;

FIG. 7 is an exploded view of the LED cooling module of FIG. 5;

FIG. 8 is a perspective view of a cooling system of an LED lamp according to another embodiment;

FIG. 9 is a cross-sectional view of an LED cooling module according to another embodiment; and

FIG. 10 is an exploded view of the LED cooling module of HG 9.

### DETAILED DESCRIPTION OF THE EMBODIMENTS

Embodiments of the invention are described more fully hereinafter with reference to the accompanying drawings, in which preferred embodiments of the invention are shown. The various embodiments of the invention may; however, be embodied in many different forms and should not be construed as limited to the embodiments set forth herein. Rather, these embodiments are provided so that this disclosure will be thorough and complete, and will fully convey the scope of the invention to those skilled in the art.

The present disclosure is specifically illustrated with reference to accompanying drawings.

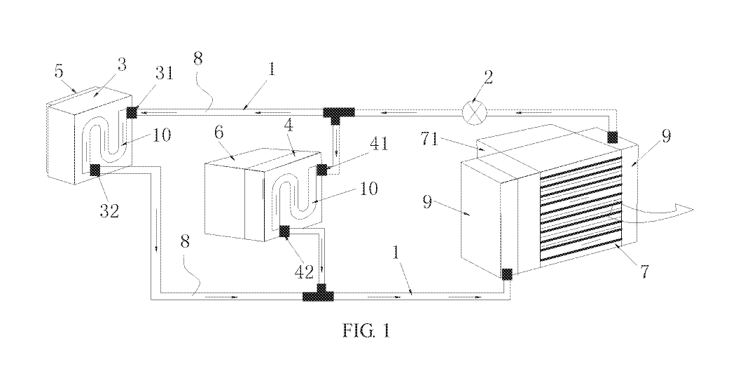

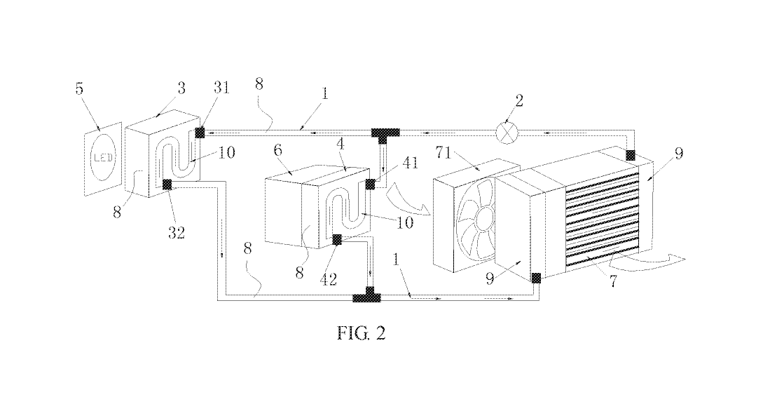

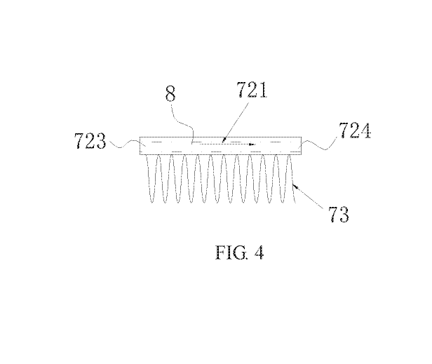

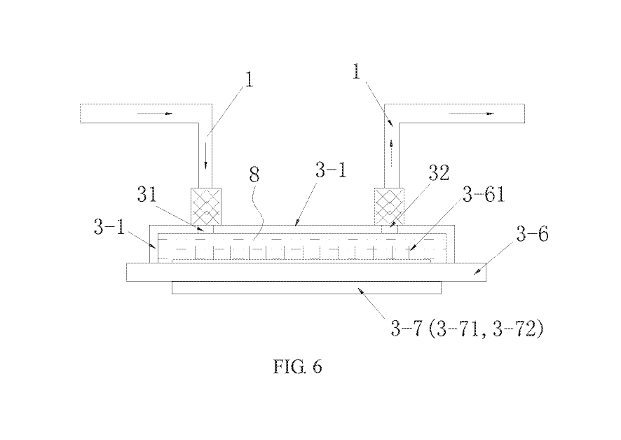

A first embodiment: a cooling system of a light emitting diode (LED) lamp shown in FIG. 1 through FIG. 7 includes: a circulatory pipe 1 and a pump 2, an LED cooling module 3 and a power source cooling module 4. The LED cooling module 3 is a fluid cooling mechanism for an LED lamp 5, the power source cooling module 4 is a fluid cooling mechanism for an LED lamp power source module 6. The circulatory pipe 1 is connected to the LED cooling module 3 and the power source cooling module 4. The specific connection mode is shown as FIG. 1 and FIG. 2: the LED cooling module 3 and the power source cooling module 4 are connected to the circulatory pipe 1 in parallel; the pump 2 is assembled to the circulatory pipe 1, causing the fluid in the circulatory pipe 1 to flow through the LED cooling module 3 and the power source cooling module 4 and form a circulatory flow, thereby achieving a cooling and temperature reducing function of the LED lamp 5 and the power source module 6.

Specifically, in the illustrated embodiment, the circulatory pipe 1 includes a hose or a metallic pipe having a cooling function, such as a rubber pipe, an aluminum pipe or a copper pipe and so on. In order to improve a cooling efficient of the fluid, the circulatory pipe 1 is further provided with a heat sink 7, the heat sink 7 includes a fan 71 and a water passage 72. At the same time, in order to increase a cooling area of the water passage 72, the water passage 72 is consisted by a plurality of sheet-like delivery pipes 721, each has a square cross-section, each sheet-like delivery pipe 721 is fixedly provided with a cooling sheet 73 having a wavy sheet-like structure. Each cooling sheet 73 and corresponding sheet-like delivery pipe 721 are fixed together to form an integrally structure, to improve a heat conducive and cooling function of the fluid in the water passage 72. Both the water passage 73 and the cooling sheet 73 are made of heat conductive materials, for example, metallic materials such as copper or aluminum. The cooling sheet 73 is configured to conduct the heat of the fluid 8 in the sheet-like delivery pipes 721. The sheet-like delivery pipes 721 includes an inlet 723 and an outlet 724 opposite to the inlet 723. The inlet 723 and the outlet 724 of the sheet-like delivery pipe 721 are directly connected to the circulatory pipe 1, causing the fluid in the circulatory pipe 1 to circulatory flow through the water passage 72, and transfer the heat to the cooling sheet 73 to reduce a temperature. The fan 71 is assembled to a side of the water passage 72 to enable the fan 71 to blow air through the water passage 72 and bypass the cooling sheet 73, achieving a fast cooling function.

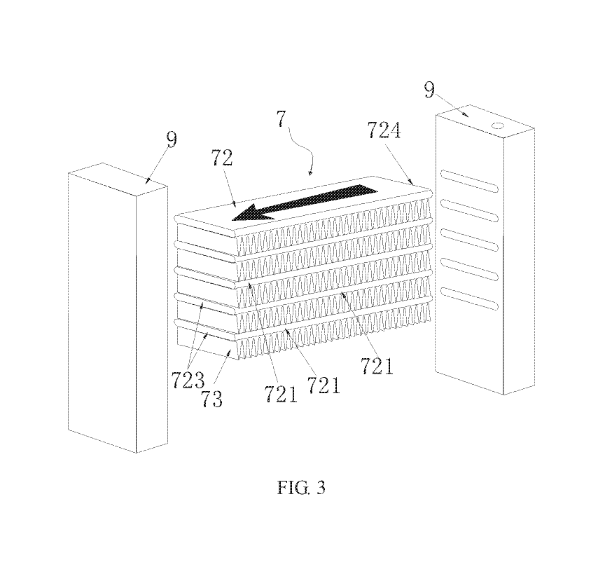

Further, each of the inlet 723 and the outlet 724 of the water passage 72 is connected to a water collector tank 9. The plurality of the sheet-like delivery pipes 721 are stacked, as shown in FIG. 3, the plurality of cooling sheets 73 are spaced from each other and distributed on the plurality of sheet-like delivery pipes 721, and are fixed to each other. The two water connector tanks 9 are located on opposite ends of each of the water passage 72 and the cooling sheet 73, respectively. The water connector tanks 9, the water passage 72, and the cooling sheet 73 form an integrally structure, i.e. the plurality of sheet-like delivery pipes 721 are stacked, each sheet-like delivery pipe 72 is provided with a wavy cooling sheet 73. The two water collector tanks 9 are connected to opposite ends of the water passage 72. The inlet 723 and the outlet 724 of the sheet-like delivery pipe 721 are in communication with the two water connector tanks 9 which are positioned on opposite ends of the water passage 72. The circulatory pipe 1 is connected to the sheet-like delivery pipe 721 of the water passage 72 via the water collector tank 9, when the fluid 8 flows circulatory, the fluid 8 in the circulatory pipe 1 flows from the water collector tank 9 on an end of the water passage 72 towards the water collector tank 9 on an opposite end of the water passage 72 via the sheet-like delivery pipe 721.

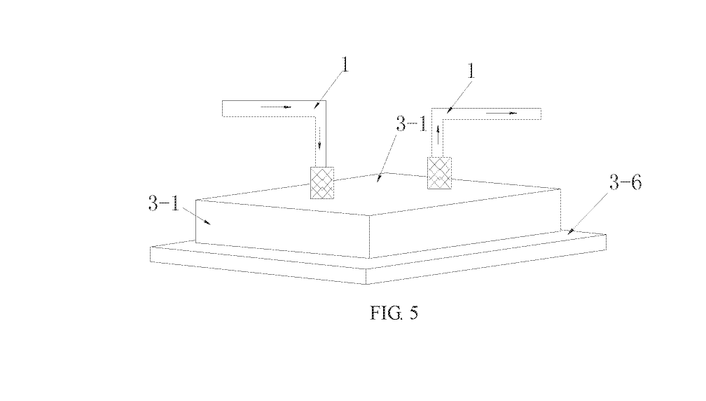

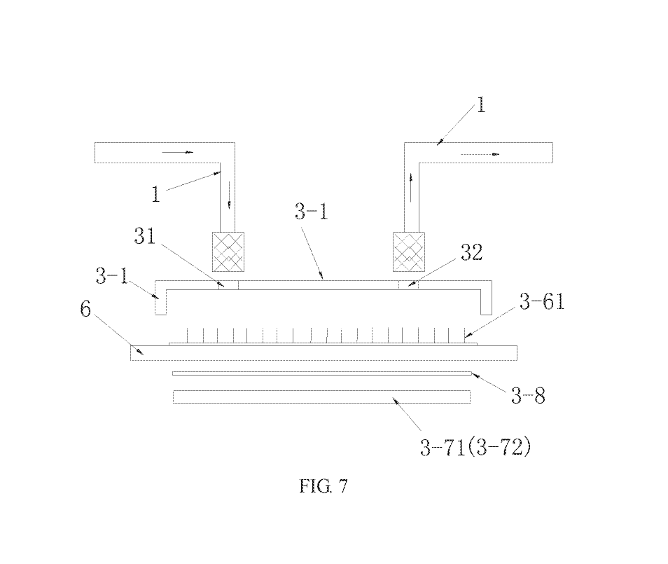

The LED cooling module 3 is a first sealing box closely contacting a base of the LED lamp 5 and is made of heat conducive materials (such as metallic materials of copper, and aluminum), the LED cooling module 3 is configured to receive the fluid, as shown in FIG. 5 and FIG. 7. The LED cooling module 3 includes a sealing case 3-1 which is provided with a first inlet 31 and a first outlet 32 connected to the external circulatory pipe 1, the circulatory cooling fluid 8 is poured into the sealing case 3-1 via the first inlet 31, and is discharged via the first outlet 32. The sealing case 3-1 has a side panel and a heating body 3-7. The side panel is consisted by a cooling plate 3-6. The cooling plate 3-6 is laminated on the heating body 3-7. The heat of the heating body 3-7 is conducted to the cooling fluid in the sealing case 3-1 via the cooling plate 3-6 to perform a circulatory cooling process. The first inlet 31 and the first outlet 32 of the first sealing box are in communication with the circulatory pipe 1, respectively. The power source cooling module 4 is a second sealing box closely contacting the power source module 6 and is made of heat conducive materials (such as metallic material of copper, and aluminum), the power source cooling module 4 is configured to receive the fluid. The second sealing box has a second inlet 41 and a second outlet 42 in communication with the circulatory pipe 1, respectively.

Further, the heating body 3-7 is a LED lamp 3-71. The cooling plate 3-6 is provided with a plurality of cooling sheets 3-61 in an inner side thereof, the cooling sheet 3-61 is immersed in the cooling fluid 8, and the cooling sheet 3-61 and the cooling plate 3-6 are integrally formed by metallic materials such as aluminum or copper which has better heat conductive characteristics. The plurality of cooling sheets 3-61 are parallel arranged on the cooling plate 3-6, and are evenly distributed in an inner chamber of the sealing case 3-1, enabling the heat of the heating body to be better conducted to the cooling fluid via the cooling plate 3-6 and the cooling sheet 3-61. The cooling fluid 8 can adopt a cooling liquid such as silicone oil and water which has better heat conductive property.

The cooling plate 3-6 and the heating body 3-7 contact each other tightly by a heat conductive adhesive 3-8, such as adopting a cooling silica gel, to better conduct the heat of the heating body 3-7 to the cooling plate 3-6 via the heat conductive adhesive 3-8, and the heat is conducted to the cooling fluid 8 via the cooling plate 3-6 and the cooling sheet 3-61. In consideration of improving a heat conductive effect, both the sealing case 3-1 and the circulatory pipe 2 are made of heat conductive materials, such as aluminum and copper.

Each of the first sealing box and the second sealing box is provided with a cooling conduit 10 therein, the cooling conduit 10 is a copper pipe, an aluminum pipe, or a ceramic pipe which has a structure of S shape, annular shape, or slotted shape. The cooling conduit 10 extends through the first sealing box and the second sealing box, the cooling conduit 10 has an inlet and an outlet connected to the circulatory pipe 1, respectively. For simple, the cooling conduit 10 is a delivery pipe extending through the first sealing box and the second sealing box which receives the fluid, the cooling conduit 10 is configured for flowing the fluid circulatory.

The cooling system further includes a protective mechanism, the protective mechanism includes a temperature sensor and a control power circuit. The temperature sensor is located on a position of the base of the LED lamp 5, the control power circuit is connected to the power supply module 6. When the temperature detects a temperature signal of the position of the base of the LED lamp 5, the temperature signal is transferred to the power source module 6 via the control power circuit, after the power source module 6 receives the temperature signal, whether the temperature signal exceeds a preset value or not is determined, when the temperature signal exceeds the preset value, the LED lamp 5 is switched off immediately, and stops working, thus achieving a self-protection function.

When the disclosure is used, the LED cooling module 3 (the first sealing box), the power source cooling module 4 (the second sealing box) and the water collector tank 9 are filled with the fluid 8, the fluid 8 includes a liquid that has better heat conductive property such as water or cooling oil. When the LED lamp is switched on, the water pump 2 located on the circulator pipe 1 is initiated at the same time, causing the fluid 8 to flow circulatory in the LED cooling module 3 (the first sealing box) of the LED lamp 5, the power source cooling module 4 (the second sealing box) of the power source module 6, and the water collector tank 9 of the heat sink 7. In the circulation of the fluid 8, the heat generated by the LED lamp 5 is transferred to the circulatory fluid 8 in the cooling conduit 10 via the fluid 8 in the LED cooling module 3, the heat of the power source module 6 is transferred to the circulatory fluid 8 in the cooling conduit 10 via the fluid 8 in the power source cooling module 4. When the circulatory fluid 8 flows, by the circulatory pipe 1, the circulator fluid 8 carrying heat flows through the sheet-like delivery pipes 721 of the heat sink 7, and is conducted out via the sheet-like delivery pipes 721 and the cooling sheets 73, and the fan 71 blows air to reduce the temperature, and achieving a fast cooling and a temperature drop function of the fluid 8, and the fluid 8 flows back to the LED cooling module 3 and the power source cooling module 4 again to perform a temperature drop to the LED lamp 5 and the power source module 6 once again, it is repeated similarly to achieve a better cooling function of the LED lamp 5 and the power source module 6.

A second embodiment: the technical characteristic of the second embodiment is: the LED cooling module 3 (the first sealing box) and the power source cooling module 4 (the second sealing box) of the power source module 6 do not have a cooling pipe 10, the other elements and configuration of the second embodiment are same as that of the first embodiment.

When the present disclosure is used, the LED cooling module 3 (the first sealing box) of the LED lamp 5, the power source cooling module 4 (the second sealing box) and the water collector tank 9 are filled with the fluid 8, the fluid 8 includes a liquid that has a better heat conductive property such as water and cooling oil. When the LED lamp 5 is switched on, the water pump 2 located on the circulator pipe 1 is initiated at the same time, causing the fluid 8 to flow circulatory in the LED cooling module 3 (the first sealing box) of the LED lamp 5, the power source cooling module 4 (the second sealing box) of the power source module 6, and the water collector tank 9 of the heat sink 7. In the circulation of the fluid 8, the heat generated by the LED lamp 5 is transferred to the circulatory fluid 8, the heat of the power source module 6 is transferred to the circulatory fluid 8 via the power source cooling module 4. When the circulatory fluid 8 flows, by the circulatory pipe 1, the circulator fluid 8 flows through the sheet-like delivery pipes 721 of the heat sink 7, and the heat carried by the fluid 8 is conducted out via the sheet-like delivery pipes 721 and the cooling sheets 73, and the fan 71 blows air to reduce the temperature, and achieving a fast cooling and a temperature drop of the fluid 8, and the fluid 8 flows back to the LED cooling module 3 and the power source cooling module 4 again to perform a temperature reducing to the LED lamp 5 and the power source module 6 once again, it is repeated similarly to achieve a better cooling function of the LED lamp 5 and the power source module 6.

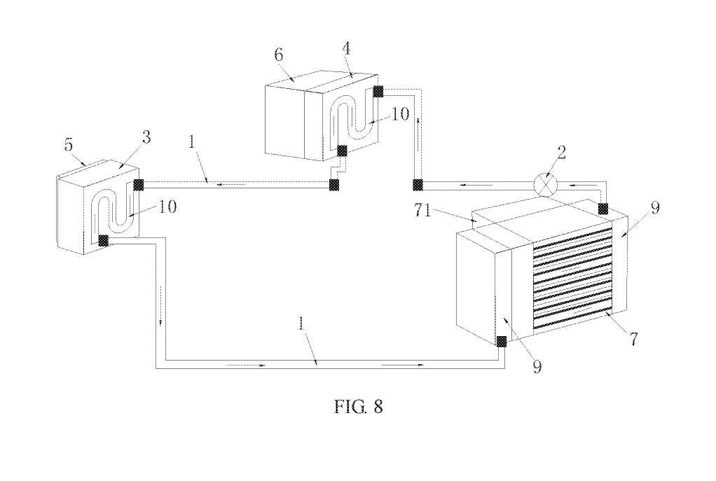

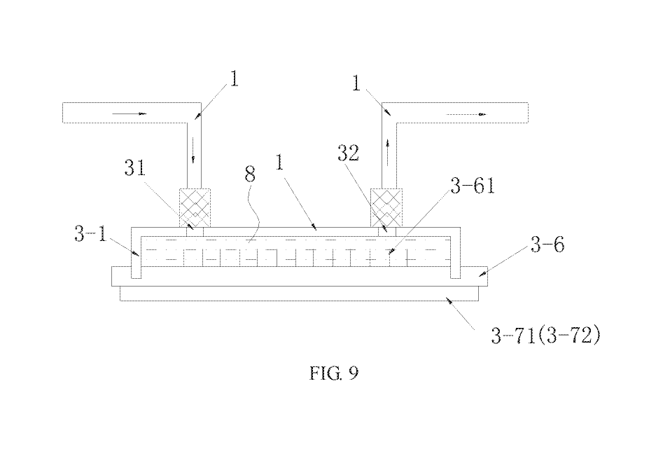

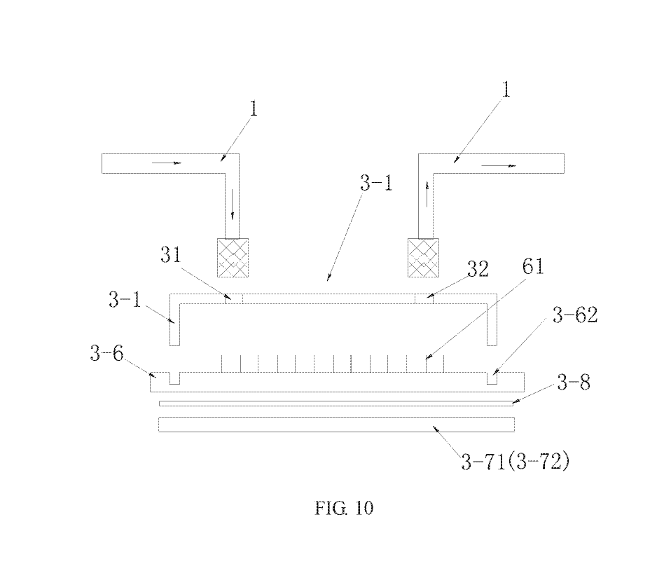

A third embodiment: FIG. 8 through FIG. 10 show a cooling system of a LED lamp, the technical characteristic of the illustrated embodiment is: the LED cooling module 3, the power source cooling module 4 and the circulatory pipe 1 are connected by a series connection. In order to facilitate to the assembly, the cooling plate 3-6 is provided with a pair of assembly grooves 3-62, the sealing case 3-1 has a square or a circular shape and has a peripheral side edge 3-11 engaging the assembly grooves 3-62 tightly and assembled to the cooling plate 3-6. In order to improve a tightness and a stability of the assembly, the engaging position of the side edge 3-11 and the assembly grooves 3-62 are filled with an anti-leakage sealing material or each assembly groove 3-62 is provided with a sealing joint strip. The heating body 3-7 is a power source module 3-72, the other elements and configuration of the second embodiment are same as that of the first embodiment.

A fourth embodiment: the technical characteristic of the illustrated embodiment is: the inlet 723 or the outlet 724 are provided with one water collector tank 9 receiving the fluid 8, i.e. a single water collector tank 9 is adopted, the other elements and configuration of the second embodiment are same as that of the first embodiment.

The above are several embodiments of the present invention described in detail, and should not be deemed as limitations to the scope of the present invention. It should be noted that variations and improvements will become apparent to those skilled in the art to which the present invention pertains without departing from its spirit and scope. Therefore, the scope of the present invention is defined by the appended claims.

What is claimed is:

1. A cooling system of a light emitting diode (LED) lamp, comprising: a circulatory pipe, a pump, an LED cooling module, and a power source cooling module, wherein the LED cooling module is a fluid cooling mechanism for an LED lamp, the power source cooling module is a fluid cooling mechanism for an LED lamp power source module, the circulatory pipe is connected to the LED cooling module and the power source cooling module, the pump is assembled to the circulatory pipe, causing a fluid in the circulatory pipe to flow through the LED cooling module and the power source cooling module and form a circulatory flow, thereby achieving a cooling and temperature reducing function of the LED lamp and the power source module at the same time.

2. The cooling system of an LED lamp according to claim 1, wherein the circulatory pipe is further provided with a heat sink.

3. The cooling system of an LED lamp according to claim 2, wherein the heat sink comprises a fan and a water passage, the water passage is consisted by a plurality of sheet-like delivery pipes, each has a square cross-section, each sheet-like delivery pipe is provided with a cooling sheet having a wavy sheet-like structure, the cooling sheet is configured to conduct the heat of the fluid in the sheet-like delivery pipes, the sheet-like delivery pipes comprise an inlet and an outlet connected to the circulatory pipe, respectively, causing the fluid in the circulatory pipe to circulatory flow through the water passage, and transfer the heat to the cooling sheet to reduce a temperature, the fan is assembled to a side of the water passage to enable the fan to blow air through the water passage and bypass the cooling sheet.

4. The cooling system of an LED lamp according to claim 3, wherein each of the inlet and the outlet of the water passage is connected to a water collector tank, the two water connector tanks are located on opposite ends of each of the water passage and the cooling sheet, the two water connector tanks, the water passage, and the cooling sheet form an integrally structure, or the inlet and the outlet are provided with one water connector tank receiving the fluid, the circulatory pipe is connected to the water passage via the water passage.

5. The cooling system of an LED lamp according to claim 1, wherein the LED cooling module is a first sealing box closely contacting a base of the LED lamp and is made of heat conducive materials, the LED cooling module is configured to receive the fluid, the LED cooling module comprises a sealing case which is provided with a first inlet and a first outlet connected to the circulatory pipe, the fluid is poured into the sealing case via the first inlet, and is discharged via the first outlet, the sealing case has a side panel and a heating body, the side panel is consisted by a cooling plate laminated on the heating body, the heat of the heating body is conducted to the fluid in the sealing case via the cooling plate to perform a circulatory cooling process.

6. The cooling system of an LED lamp according to claim 1, wherein the power source cooling module is a second sealing box closely contacting the power source module and is made of heat conducive materials, the power source cooling module is configured to receive the fluid.

7. The cooling system of an LED lamp according to claim 6, wherein each of the first sealing box and the second sealing box is provided with a cooling conduit, the cooling conduit extends through the first sealing box and the second sealing box, and the cooling conduit has an inlet and an outlet which are connected to the circulatory pipe, respectively.

8. The cooling system of an LED lamp according to claim 1, wherein the LED cooling module and the power source cooling module are connected to the circulatory pipe in parallel or by a series connection.

9. The cooling system of an LED lamp according to claim 5, wherein the cooling plate is provided with a plurality of cooling sheets in an inner side thereof, the plurality of cooling sheets are evenly distributed in an inner chamber of the sealing case.

10. The cooling system of an LED lamp according to claim 5, wherein the cooling plate is provided with a pair of assembly grooves, the sealing case has a square or a circular shape and has a peripheral side edge engaging the assembly grooves tightly and assembled to the cooling plate.

11. The cooling system of an LED lamp according to claim 10, wherein an engaging position of the side edge and the assembly groove is filled with an anti-leakage sealing material.

12. The cooling system of an LED lamp according to claim 5, wherein the cooling plate and the heating body contact each other tightly by a heat conductive adhesive.

13. The cooling system of an LED lamp according to claim 5, wherein the heating body is an LED lamp or a power source module.

14. The cooling system of an LED lamp according to claim 5, wherein the circulatory pipe and/or the sealing case are made of heat conductive materials.

15. The cooling system of an LED lamp according to claim 5, further comprising a protective mechanism wherein, the protective mechanism comprises a temperature sensor and a control power circuit.

16. A cooling system, comprising:
an LED cooling module for cooling an LED lamp;
a power source cooling module for cooling an LED lamp power source module; and
a pump for flowing a cooling fluid through the LED cooling module and the power source cooling module.

17. The cooling system of claim 16, further comprising a heat sink for receiving the cooling fluid after the cooling fluid flowed through the LED cooling module and the power source cooling module.

18. The cooling system of claim 17, wherein the heat sink comprises a fan for blowing air toward a water passage that receives the cooling fluid.

19. A method of cooling a light emitting diode (LED) lamp, comprising:
a pump flowing a cooling fluid through an LED cooling module and a power source cooling module;
the LED cooling module cooling an LED lamp; and
the power source cooling module cooling an LED lamp power source module.

20. The method of claim 19, further comprising a heat sink receiving the cooling fluid after the cooling fluid flowed through the LED cooling module and the power source cooling module.
